(19) United States
(12) Patent Application Publication
(10) Pub. No.: US 2007/0183031 A1
(43) Pub. Date: Aug. 9, 2007

(54) CONTROL DEVICE FOR CONTROLLING AN ASTRONOMICAL TELESCOPE AND A METHOD FOR CONTROLLING THE SAME

(76) Inventors: Wen XU, Nanjing (CN); Ning XU, Nanjing (CN)

Correspondence Address: MATTHIAS SCHOLL, 14781 MEMORIAL DRIVE, SUITE 1319, HOUSTON, TX, 77079, US

(21) Appl. No.: 11/670,521

(22) Filed: Feb. 2, 2007

(30) Foreign Application Priority Data
Feb. 9, 2006 (CN) 200610038199.2

(51) Int. Cl. G02B 23/00

(52) U.S. Cl. 359/399; 359/900; 700/63

(57) ABSTRACT

This invention relates to a control device for controlling an astronomical telescope and, specifically, to a control device for automatic locating of celestial bodies, and to a method for controlling an astronomical telescope. The control device comprises a power input interface, a master controller, and an intelligent motor drive controller. The master controller comprises a CPU, an optional RAM, a FLASH microprocessor, one or more buttons, an LCD, a buzzer, one or more backlight diode lamps, one or more LED lights, a serial to USB interface, and an internal serial bus. The intelligent motor drive controller comprises a chip microprocessor having IAP functions, a two-way reversible PWM driving circuit having an output end and a detection end, a direct current motor, an optical encoder, an optical encoder detection circuit, and an over-current protection circuit. By calculating the coordinates of target bodies and converting them to equatorial mount coordinates, the microprocessor in the intelligent motor controller controls the motor to run, realizing the tracking of target celestial bodies.

### CROSS-REFERENCE TO RELATED APPLICATIONS

This application claims priority to the Chinese Patent Application No. 200610038199.2 filed Feb. 9, 2006, the contents of which are incorporated herein by reference.

### BACKGROUND OF THE INVENTION

1. Field of the Invention

This invention relates to a control device for controlling an astronomical telescope and, specifically, to a control device for automatic locating of celestial bodies, and to a method for controlling an astronomical telescope.

2. Description of the Related Art

There are automatic telescope controllers known in the art. However, they have many shortcomings. Specifically, conventional automatic telescope controllers calculate the tracking speed only relatively slowly, have an inadequate tracking algorithm, and low calculation accuracy. In addition, connections between the various elements of conventional controllers are complex and often proprietary rather than universal. Conventional controllers also require that various parameters (e.g., time) be inputted each time they are set up. Moreover, conventional controllers are easily damaged if revered polarity power is connected. Conventional controllers also use two-line LCD displays which are inadequate at displaying a variety of information. They also use RS232 interfaces which are no longer used in newer PCs.

With respect to observation of celestial bodies, conventional controllers do not allow for an easy setup and calibration, and generally rely on users to align conventional polar scopes with the celestial poles, which is a rather complicated operation for many novice users. Current methods of automatic tracking of celestial bodies with portable astronomical telescopes are limited to equatorial mounts and theodolites and are incompatible with other types of mounts. Even when applied to equatorial telescopes and theodolites, the conventional methods fail when equatorial telescopes and theodolites are operated substantially outside of their base positions.

When conventional controllers are bundled with particular telescopes, telescope and mount parameters are permanently set up in the controllers and cannot be changed by users who may wish to transfer their telescopes to different mounts. In addition, conventional controllers do not feature soft-start and soft-stop functions and when electrical failure occurs, a mechanical failure generally follows.

To overcome the above-mentioned shortcoming, this invention aims to provide an improved device for controlling a portable astronomical telescope and for automatically locating celestial bodies, and an improved method for controlling a portable astronomical telescope and automatically locating celestial bodies.

### SUMMARY OF THE INVENTION

This invention provides a control device for controlling an astronomical telescope comprising a power input interface, a master controller and a motor drive controller. In certain embodiments, the control device further comprises a power output interface having a variable power output for powering a polar scope, a star locating telescope and an eyepiece. In certain embodiments, the control device further comprises a power-protected internal clock which can keep time in the absence of an external power.

In certain embodiments, the power input interface comprises a protection circuit for protecting from a reverse polarity.

In certain embodiments, the master controller comprises a CPU, an optional RAM, a FLASH microprocessor, one or more buttons, an LCD, a buzzer, one or more backlight diode lamps, one or more LED lights, a serial to USB interface, and an internal serial bus.

In certain embodiments, the serial to USB interface and the USB interface is further connected with a personal computer.

In certain embodiments, the internal serial bus comprises sockets, a serial communication and a power line, and the sockets of the internal serial bus serving to connect with external ports are universal.

In certain embodiments, the master controller is capable of displaying on the LCD simultaneously a target declination, a current declination, a height, a direction, a time, a local star time, a motor speed, a hemisphere indication, and a status of the GPS module.

In certain embodiments, the motor drive controller comprises a chip microprocessor having In-Application Programming (IAP) functions, a two-way reversible PWM driving circuit having an output end and a detection end, a direct current motor, an optical encoder, an optical encoder detection circuit, and over current protection circuit; the output end of two-way reversible PWM driving circuit is connected with the direct current motor; the microprocessor is connected to the detection end of the two-way reversible PWM driving circuit by an input interface having an A/D function; the motor drive controller has an IAP function; the motor driver controller has over-current protection function; and the control device is capable of controlling main parameters of the motor and mechanical parameters, and store the parameters in the motor drive controller.

In other aspects this invention provides a method for controlling an astronomical telescope comprising a mount, a polar scope, and a control device comprising the following steps: (a) inputting a geographical location and a time zone information into the control device, and identifying a celestial body to be observed; (b) aligning the mount with the North Celestial Pole or the South Celestial Pole using the polar scope; (c) determining a calibration function (transforming function) by using one or more known, bright celestial objects; (d) determining celestial coordinates of the celestial body to be observed, and converting the celestial coordinates into mount coordinates using the calibration function obtained in step (c); and (e) instructing the motor to orient the telescope according to the mount coordinates.

In certain embodiments, the geographical location and the time zone are inputted using an electronic map.

In certain embodiments, the controller calculates the position of Polaris or Octans using the time and geographical location information, and displays in real time the hour angle and the distance information of the Polaris or Octans in the polar telescope when the mount is aligned with the North Celestial Pole or the South Celestial Pole.

In certain embodiments, during step (c) the controller displays the distances and positions of objects used for calibration, allowing users to estimate if they are in view and choose whether or not they should be used or skipped for the purposed of calibration.

In certain embodiments, when a user desires to observe a particular celestial body, the master controller first calculates the observed location of the target celestial body, and transforms its coordinates into telescope mount position coordinates by using the transforming function obtained in step (c); after calculating the telescope mount position coordinates corresponding to the celestial coordinates of the desired celestial body, the master controller sends orders to the motor drive controller by internal serial bus; the microprocessor of the motor drive controller receives commands from the microprocessor controller in the master controller, and controls the DC motor to point the telescope to a desired location; as the celestial body changes its position with respect to the telescope, the microprocessor of the master controller then continuously recalculates the telescope mount position coordinates corresponding to the celestial coordinates of the desired celestial body; as the coordinates of the target object change with time, the master controller repeats the above calculations and repositions the telescope until the errors between the real telescope mount position coordinates and the calculated values are in a very small range.

In certain embodiments, the master controller controls the motor drive controller and dynamically tracks the celestial body depending on the telescope mount type.

In certain embodiments, the mount is an equatorial mount.

In certain embodiments, the mount is not an equatorial mount.

In certain embodiments, the motor drive controller tracks the celestial body at a constant speed.

In certain embodiments, the master controller after a delay of between one and a few seconds calculates the position of the celestial body and then, after another delay of between one and a few seconds, calculates the motor speed needed to reach that position; the master controller sends the speed order to the motor drive controller by a serial bus and allows the motor to run at this speed.

### BRIEF DESCRIPTION OF THE DRAWINGS

FIG. 1 is a functional block diagram of a control device according to one embodiment of the invention;

FIG. 2 is an electrical circuit diagram of a power interface according to one embodiment of the invention;

FIG. 3 is a functional block diagram of a master controller according to one embodiment of the invention;

FIG. 4 is a functional block diagram of a motor drive controller according to one embodiment of the invention;

FIG. 5 is a flow chart illustrating a method for controlling an astronomical telescope and for automatic location of celestial bodies using an astronomical telescope according to one embodiment of the invention;

FIG. 6 illustrates a cross-hair, setting circles, and time position indications engraved into the reticle of a polar scope according to one embodiment of the invention;

FIG. 7 is a flow chart illustrating a method for automatic location and tracking of celestial bodies using an astronomical telescope according to one embodiment of the invention.

### DETAILED DESCRIPTION OF THE EMBODIMENTS

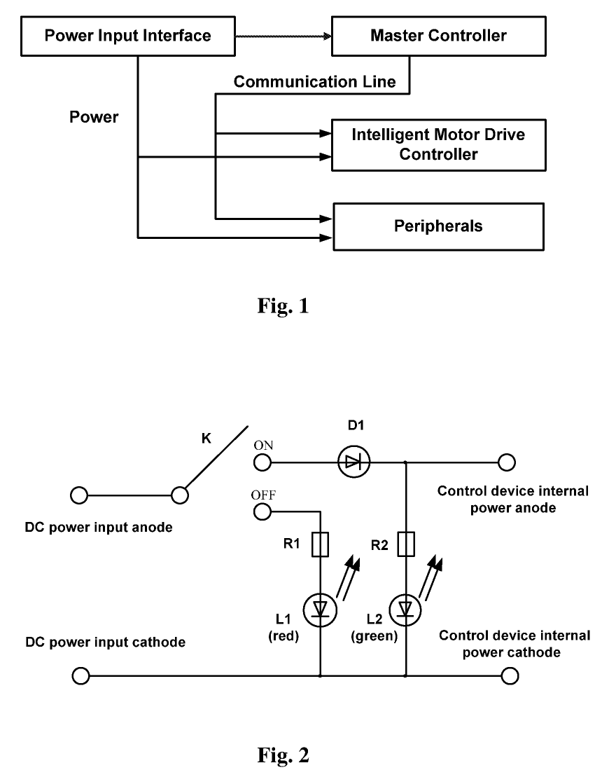

As shown in FIG. 1, a control device comprises a power input interface, a master controller, and an intelligent motor drive controller.

As shown in FIG. 2, the power input interface comprises a switch K, a diode D1, resistors R1 and R2, and LEDs L1 and L2. The input end of the switch K is connected to the positive terminal of the DC power supply. The diode D1 and the resistor R1 are connected to the two output ends of the switch K, respectively. One end of the LED L1 is connected to the resistor R1, the other end is connected to the negative terminal of the DC power supply. One end of the resistor R2 is connected with the diode D1, the other end is connected to the negative terminal of the DC power supply via the LED L2. The power input interface is designed to prevent damage to the control device if the polarity of the power supply is incorrectly connected. Specifically, when the switch K is in the off-position, and the power supply is connected with the correct polarity, the LED L1 is illuminated with red light. Conversely, when the switch K is in the off-position, and the power supply is connected with the incorrect polarity, the LED L1 is not illuminated. When the switch K is in the on-position, green LED will light indicating that the power works normally. If the power supply polarity is incorrectly connected, the device power will not be switched on because of one-way conduction of the diode D1. The power input interface protects not only the control device but also peripheral devices.

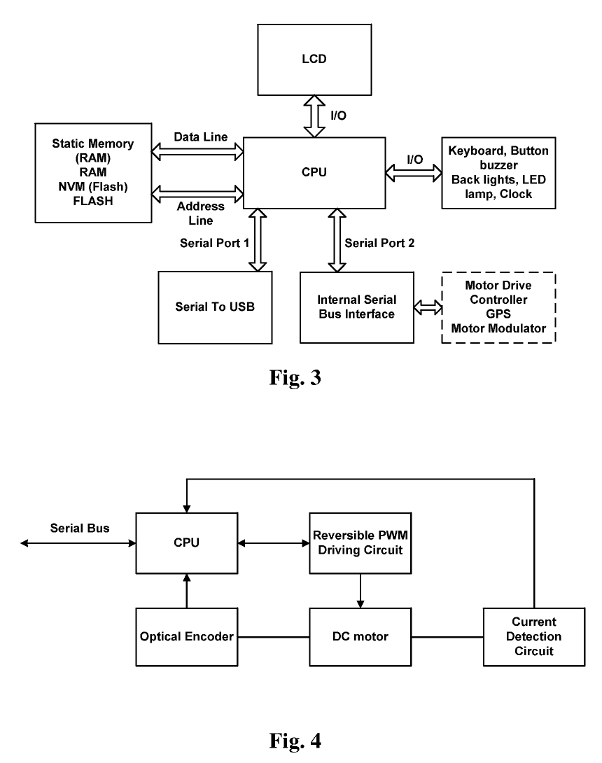

As shown in FIG. 3, the master controller comprises a central processing unit (CPU), an optional static memory (RAM), a Non-Volatile Memory (NVM, Flash), a button, an LCD, a buzzer, one or more backlight diode lights, one or more LED lights, a serial to USB interface, and an internal serial bus. The CPU adopts a 32-bit microprocessor with a FLASH microprocessor embedded therein and having an IAP (In-Application Programming) function. The IAP used herein, is a programming method applied in FLASH program memory, briefly, under the control of application program, the operation of read, erase, or write to a certain memory space can be realized. The CPU is connected to the static memory and flash memory by data bus and address bus. The CPU is connected to the button using I/O interface. The CPU is connected to the LED backlight using I/O interface. The CPU is connected to the white-light LED using I/O interface. The CPU is connected to the USB using a serial port and a serial interface chip. A second serial port connects the CPU to an internal serial bus interface. The sockets of the serial bus serving to connect with external ports are universal, and can be used randomly. All the peripheral devices to be connected with the controller are connected to the controller via the serial bus. Different peripheral devices are differentiated by using a different-coding method.

The master controller further comprises an LCD display on which the target declination, current declination, height, direction, time, local star time, motor speed, hemisphere indication (northern or southern), and the status of GPS module are displayed simultaneously. The CPU of the master controller is connected to the motor drive controller, a global positioning satellite receiver (GPS), and a motor modulator via the internal serial bus.

As shown in FIG. 4, the motor drive controller comprises a chip microprocessor having IAP and Analog-to-Digital (A/D) functions, a two-way reversible Pulse Width Modulation (PWM) driving circuit, a direct current motor, an optical encoder, an optical encoder detection circuit, and an over-current protection circuit. The microprocessor is connected to a two-way reversible PWM driving circuit using an I/O interface. The output end of the two-way reversible PWM driving circuit is connected to the motor. The microprocessor is connected to the current detection end of the two-way reversible PWM driving circuit via an input port having an A/D function.

The parameters of the motor drive controller can be set up by the master controller, and are saved in the motor drive controller by utilizing the IAP function. Thus, the same motor drive controller can be used in telescope control devices having different parameters, e.g., when different mounts are used. The A/D function of the motor drive controller serves to detect the work current of the motor. The motor drive will stop output when the current is too high. This function can protect the electronic and mechanic components.

The control device comprises further a power output interface having a variable input power being a part of the motor, the motor drive controller, or as a separate module. This interface controls the output power circuit by changing the conduction time and the turn-off time. This interface is used to provide power for such equipments as the LED lights for the Axis telescope, the mirror for locating celestial bodies, and/or the Guide Star eyepiece. The control device comprising the variable output power interface can accommodate LED lights of different parameters.

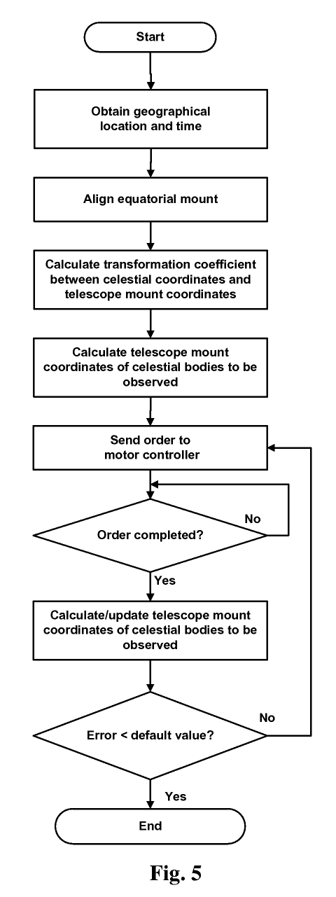

As shown in FIG. 5, a method for controlling a portable astronomical telescope so as to automatically track a celestial body comprises the following steps:

(a) Obtaining the current location and time. The controller comprises an electronic map. A user can observe the location from the electronic map by pressing buttons or utilizing other input devices. In this way, the information of the geographical longitude and latitude and the time zone at the observing location can be obtained. Alternatively, the geographic location and time can also be obtained from the GPS module.

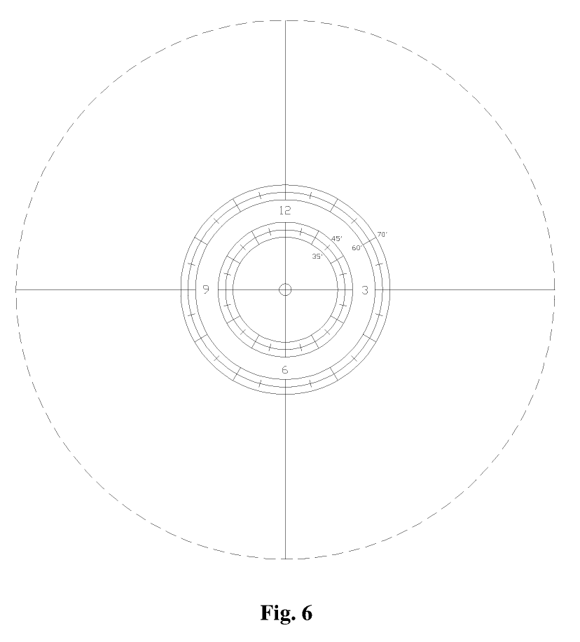

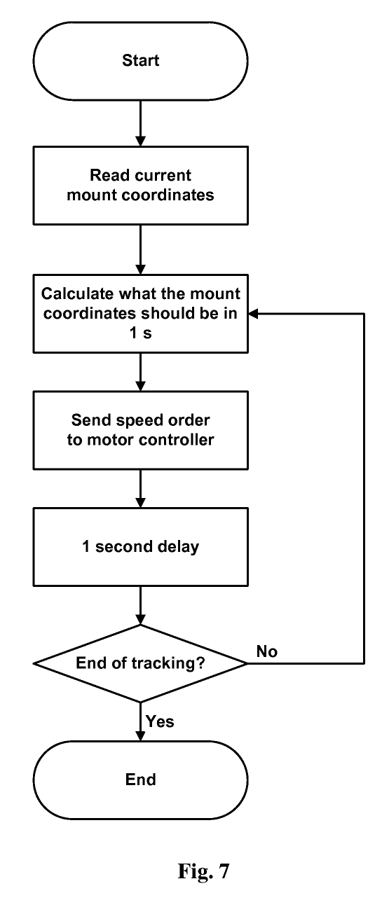

(b) Aligning the telescope equatorial mount by using a polar scope. The invention provides a simple method to align the equatorial mount with a polar scope with the help of Polaris. As shown in FIG. 6, the reticle of the polar scope is made up of the setting circles and time position indications. The controller looks up the position of the Polaris from stored parameters based on the time obtained in step (a), and displays the position in real time in the polar scope. The user first points the 12 time position displayed in the reticle of the polar scope to the zenith, then moves the equatorial mount until the position of Polaris in the polar scope is aligned with the position displayed by controller in this way easily aligning the equatorial mount with the North Celestial Pole (N.C.P.)

(c) Determining a transforming function between celestial coordinates and telescope mount position coordinates by means of astronomy method. The status of the telescope mount and the position of the telescope can be obtained from the master controller. The CPU in the master controller reads out the time and the parameters of the geographical locations from the global positioning satellite receiver module via the serial bus. Alternatively, a user can input the corresponding parameters directly. The CPU in the master controller calculates by using raw astronomical data, as well as time, and geographical location data of one or more bright stars for the purpose of calibration. The CPU then instructs the telescope drive to point the telescope at a first bright star, and displays its data, such as the name, the equatorial coordinates, and the horizontal coordinates. The user can choose different bright stars for calibration by pressing a button, and observe if the bright stars according to the changing azimuth and elevation are visible. If they are visible, then the user can confirm this with a press of a button. The controller then transmits the star data to the motor controller by bus, and controls the telescope alignment to the bright star. The user then adjusts the location of the bright star to the center telescope field, and confirms the alignment with a push of a button. The master controller reads the parameters of the motor controller, and in the meantime, records the coordinates of the one or more bright stars for the purpose of calibration. By repeating the above process, one or more celestial coordinates and the parameters of the motor controller can be obtained. Then, the transforming function between the celestial coordinates and mount coordinates is calculated by, and is stored in, the master controller.

(d) Pointing the telescope at a desired celestial body and tracking that celestial body. When the user desires to observe a particular celestial body, the master controller first calculates the observed location of the target celestial body, and then transforms its coordinates into telescope mount position coordinates by using the transforming function obtained in step (c). After calculating the telescope mount position coordinates corresponding to the celestial coordinates of the desired celestial body, the master controller sends orders to the motor drive controller by internal serial bus. The microprocessor of the motor drive controller receives commands from the microprocessor controller in the master controller, and controls the DC motor to point the telescope to a desired location. As the celestial body changes its position with respect to the telescope, the microprocessor of the master controller then continuously recalculates the telescope mount position coordinates corresponding to the celestial coordinates of the desired celestial body. As the coordinates of the target object change with time, the master controller repeats the above calculations and repositions the telescope until the errors between the real telescope mount position coordinates and the calculated values are in a very small range.

(e) After finishing automatic location of a celestial body, the master controller controls the motor drive controller dynamically constantly tracking the celestial body according to the type of telescope mount. For equatorial mounts, the motor drive controller tracks the celestial body at a constant speed. For other types of telescope mounts, the master controller first calculates the position that a tracked celestial body will have after a delay of between one and a few seconds, and then calculates the motor speed needed to reach that position within these one or few seconds. The master controller sends the speed order to the motor drive controller by a serial bus and allows the motor to run at this speed. Repeating this process, the controller can control the telescope to track celestial bodies.

The benefits of the control device and methods according to the present invention are summarized below: (1) The present invention provides a method and device for controlling a portable astronomical telescope and for automatic searching and tracking of celestial bodies. (2) The control device has a power input interface and a power input protection circuit. The control devices will not be damaged by a reverse connection of positive and negative poles. (3) The internal clock of the control device can keep counting time in the absence of external power. Accordingly, there is no need to enter time each time the device is used. (4) The present invention provides the an embedded serial to USB interface, which is suitable for use with PCs without a RS232 interface. (5) The present invention provides a controller, which has an LCD display for displaying various parameters in real time. (6) All the interfaces of the control devices are universal, and thereby, can be used and exchanged randomly. (7) The motor drive controller has an over-current protection circuit, and can rapidly exchange orders and data with the master controller by internal serial bus. (8) The motor drive controller has IAP. It can change the parameters by the controller, for different slowdown ratio and different types of telescope mounts. The motor drive controller directly calculates telescope mount position coordinates according to the parameters set up by controller and outputs the parameters to the motor. (9) The control device comprises a power output interface with variable power output. This interface is used to illuminate the polar scope, the searching star scope, and the guiding star eyepiece. (10) The present invention provides a method of using a polar scope to align the equatorial mount; this method is simple and visual. (11) During the automatic location and tracking according to the present invention, the method of choosing a celestial body is simple and visual. In the case of certain celestial bodies are being obscured (e.g., by clouds), the celestial body can be selected by the user according to a real situation instead of being found by automatically selecting the celestial body and rotating the telescope to the certain position. (12) The present invention provides a method of tracking objects. This method is suitable for different telescope mounts. The telescope moves smoothly when tracking.

### EXAMPLES

### Example 1

### Calculating the Transforming Function Between Celestial Coordinates and Telescope Mount Position Coordinates

The equatorial coordinate of a first celestial body comprises the Right ascension=RA_S1 and the Declination=DEC_S1, and its coordinates in equatorial mount or theodolite comprise the Right ascension=RA_M1 and the Declination=DEC_M1. These coordinates are transformed to rectangular coordinates: X_S1, Y_S1, Z_S1 and X_M1, Y_M1, Z_M1, respectively. The equatorial coordinate of a second celestial body is Right ascension=RA_S2 and Declination=DEC_S2, and its coordinates in equatorial mount or theodolite is Right ascension=RA_M2 and Declination=DEC_M2. These coordinates are transformed to rectangular coordinates: X_S2, Y_S2, Z_S2 and X_M2, Y_M2, Z_M2, respectively.

Based on the rectangular coordinates of the two celestial bodies, a transformation matrix (T) and its inverse matrix (T)⁻¹ (the transforming function) can be calculated, satisfying the following equations:

$$\begin{matrix}( \begin{matrix}X\_S1 \\ Y\_S1 \\ Z\_S1\end{matrix} ) = ( T ) ( \begin{matrix}X\_M1 \\ Y\_M1 \\ Z\_M1\end{matrix} ) & ( \begin{matrix}X\_S2 \\ Y\_S2 \\ Z\_S2\end{matrix} ) = ( T ) ( \begin{matrix}X\_M2 \\ Y\_M2 \\ Z\_M2\end{matrix} ) \\ ( \begin{matrix}X\_M1 \\ Y\_M1 \\ Z\_M1\end{matrix} ) = {( T )}^{- 1} ( \begin{matrix}X\_S1 \\ Y\_S1 \\ Z\_S1\end{matrix} ) & ( \begin{matrix}X\_M2 \\ Y\_M2 \\ Z\_M2\end{matrix} ) = {( T )}^{- 1} ( \begin{matrix}X\_S2 \\ Y\_S2 \\ Z\_S2\end{matrix} )\end{matrix}$$

The transformation between the celestial coordinate of other celestial bodies and the equatorial mount coordinates of these bodies can be carried out through the above matrixes.

### Example 2

### Calculating Errors Between the Real Telescope Mount Position Coordinates and Their Calculated (Theoretical) Values

According to the original parameters, time, and geographical position of the celestial body, the equatorial coordinates that a celestial body would assume after a delay time of 1 second can be calculated.

Based on the expressions in Example 1, the coordinates, namely Right ascension=RA_M0 and Declination=DEC_M0, of the celestial body in the equatorial mount can be calculated. Since the coordinates recorded in the equatorial mount within the motor drive controller is Right ascension=RA_M1 and Declination =DEC_M1, the error can be calculated as follows:

The error of the right ascension=RA_M1−RA_M0.

The error of the declination=DEC_M1−DEC_M0.

The speed error of the right ascension=the error of the right ascension/1 second.

The speed error of the declination=the error of the declination/1 second.

The master controller repeats the above calculations and repositions the telescope until the errors between the real telescope mount position coordinates and the calculated values are in a very small range. The error range is preferably less than about 20 arcsecs/s, more preferably less than about 2 arcsecs/s and most preferably less than 0.1 arcsec/s.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed is:

1. A control device for controlling an astronomical telescope comprising a power input interface, a master controller and a motor drive controller

2. The control device of claim 1, wherein said power input interface comprises a protection circuit for protecting from a reverse polarity.

3. The control device of claim 1, further comprising a power output interface having a variable power output for powering a polar scope, a star locating telescope and an eyepiece.

4. The control device of claim 1, wherein said master controller comprises a CPU, an optional RAM, a FLASH microprocessor, one or more buttons, an LCD, a buzzer, one or more backlight diode lamps, one or more LED lights, a serial to USB interface, and an internal serial bus.

5. The control device of claim 4, wherein said serial to USB interface and the USB interface is further connected with a personal computer.

6. The control device of claim 4, comprising further a power-protected internal clock which can keep time in the absence of an external power.

7. The control device of claim 4, wherein
said internal serial bus comprises sockets, a serial communication and a power line, and
said sockets of said internal serial bus serving to connect with external ports are universal.

8. The control device of claim 4, wherein the master controller is capable of displaying on said LCD simultaneously a target declination, a current declination, a height, a direction, a time, a local star time, a motor speed, a hemisphere indication, and a status of the GPS module.

9. The control device of claim 1, wherein
said motor drive controller comprises a chip microprocessor having In-Application Programming (IAP) functions, a two-way reversible PWM driving circuit having an output end and a detection end, a direct current motor, an optical encoder, an optical encoder detection circuit, and over current protection circuit;
the output end of two-way reversible PWM driving circuit is connected with said direct current motor;
the microprocessor is connected to said detection end of said two-way reversible PWM driving circuit by an input interface having an A/D function;
the motor drive controller has an IAP function;
the motor driver controller has over-current protection function; and
the control device is capable of controlling main parameters of the motor and mechanical parameters, and store the parameters in the motor drive controller.

10. A method for controlling an astronomical telescope comprising a mount, a polar scope, and a control device of claim 1 comprising the following steps:
(a) inputting a geographical location and a time zone information into said control device, and identifying a celestial body to be observed;
(b) aligning said mount with the North Celestial Pole or the South Celestial Pole using said polar scope;
(c) determining a calibration function by using one or more known, bright celestial objects;
(d) determining celestial coordinates of said celestial body to be observed, and converting said celestial coordinates into mount coordinates using the calibration function obtained in step (c); and
(e) instructing said motor to orient said telescope according to said mount coordinates.

11. The method of claim 10, wherein said geographical location and said time zone are inputted using an electronic map.

12. The method of claim 10, wherein the controller calculates the position of Polaris or Octans using the time and geographical location information, and displays in real time the hour angle and the distance information of the Polaris or Octans in the polar telescope when the mount is aligned with the North Celestial Pole or the South Celestial Pole

13. The method of claim 10, wherein during step (c) the controller displays the distances and positions of objects used for calibration, allowing users to estimate if they are in view and choose whether or not they should be used or skipped for the purposed of calibration.

14. The method of claim 10, wherein when a user desires to observe a particular celestial body,
the master controller first calculates the observed location of the target celestial body, and transforms its coordinates into telescope mount position coordinates by using the transforming function obtained in step (c);
after calculating the telescope mount position coordinates corresponding to the celestial coordinates of the desired celestial body, the master controller sends orders to the motor drive controller by internal serial bus;
the microprocessor of the motor drive controller receives commands from the microprocessor controller in the master controller, and controls the DC motor to point the telescope to a desired location;
as the celestial body changes its position with respect to the telescope, the microprocessor of the master controller then continuously recalculates the telescope mount position coordinates corresponding to the celestial coordinates of the desired celestial body;
as the coordinates of the target object change with time, the master controller repeats the above calculations and repositions the telescope until the errors between the real telescope mount position coordinates and the calculated values are in a very small range.

15. The method of claim 10, wherein the master controller controls the motor drive controller and dynamically tracks the celestial body depending on the telescope mount type.

16. The method of claim 10, wherein said mount is an equatorial mount.

17. The method of claim 10, wherein said mount is not an equatorial mount.

18. The method of claim 16, wherein the motor drive controller tracks the celestial body at a constant speed.

19. The method of claim 17, wherein the master controller after a delay of between one and a few seconds calculates the position of the celestial body and then, after another delay of between one and a few seconds, calculates the motor speed needed to reach that position; the master controller sends the speed order to the motor drive controller by a serial bus and allows the motor to run at this speed.
